(19) United States
(12) Patent Application Publication
(10) Pub. No.: US 2016/0184875 A1
(43) Pub. Date: Jun. 30, 2016

(54) Hot rolled steel sheet for oil country tubular goods, method for manufacturing the same and steel pipe manufactured using the same

(71) Applicant: POSCO, Pohang-si (KR)

(72) Inventors: Kyung Min Noh, Gwangyang-si (KR); Min Sung Joo, Gwangyang-si (KR)

(21) Appl. No.: 14/757,443

(22) Filed: Dec. 23, 2015

(30) Foreign Application Priority Data
Dec. 26, 2014 (KR) 10-2014-0190242

(51) Int. Cl. B21B 1/16; C22C 38/38; C22C 38/32; F16L 9/02; C22C 38/26; C22C 38/02; C22C 38/00; C21D 8/02; C22C 38/28

(52) U.S. Cl. CPC B21B 1/16; C21D 8/0263; C22C 38/38; C22C 38/32; C22C 38/28; C22C 38/26; C22C 38/02; C22C 38/002; C22C 38/001; F16L 9/02

(57) ABSTRACT

Provided is a hot rolled steel sheet for oil country tubular goods (OCTG). The hot rolled steel sheet for oil country tubular goods (OCTG) according to an aspect of the present invention comprises C: 0.08 to 0.18 wt %, Si: 0.10 to 0.50 wt %, Mn: 1.2 to 2.0 wt %, P: 0.020 wt % or less, S: 0.003 wt % or less, Nb: 0.04 to 0.1 wt %, Cr: 0.05 to 0.5 wt %, Ti: 0.01 to 0.05 wt %, B: 0.0005 to 0.003 wt %, Ca: 0.001 to 0.006 wt %, N: 0.008 wt % or less, a balance of Fe and inevitable impurities, and satisfy Relational Expression 1,

16≦30[C]+5[Mn]+5[Si]+6[Cr]+600[B]<17.5 [Relational Expression 1]
wherein, [C], [Mn], [Si], [Cr] and [B] refer to wt % of each ingredient.

### CROSS-REFERENCE TO RELATED APPLICATION

This application claims the priority and benefit of Korean Patent Application No. 10-2014-0190242, filed on Dec. 26, 2014, in the Korean Intellectual Property Office, the disclosure of which is incorporated herein by reference.

### BACKGROUND

The present invention relates to a hot rolled steel sheet and steel pipe for oil country tubular goods (OCTG), which can be used in oil well pipes and the like for developing petroleum or natural gas reserves, and more particularly, to a hot rolled steel sheet for oil country tubular goods (OCTG), able to satisfy API standards without requiring an additional heat treatment, a method for manufacturing the same and a method for manufacturing a steel pipe manufactured by the same.

The development of oil wells and natural gas wells (hereinafter, generally termed oil well) is moving into somewhat harsh territory, and efforts for increasing cost-effectiveness to reduce production costs have been ongoing. In steel pipes for oil country tubular goods (OCTG), used to develop oil well infrastructure, demands for reducing costs required for heat treatments (quenching and tempering), by manufacturing a high strength steel pipe for oil country tubular goods (OCTG) without requiring a heat treatment after pipe making, is growing.

For example, Patent Document 1 discloses a method for manufacturing an electric resistance welded steel pipe having improved strength by rolling a steel slab having a carbon content of 0.2 to 0.3 wt % followed by cooling thereof to a temperature of 450° C. to 500° C. to form a bainite and martensite structure.

However, the invention of Patent Document 1 can satisfy the strength requirement of API standard 5CT P110, but there may be problems in that an equipment load may be high when manufacturing the pipe due to yield strength being inclined toward the upper limit of 900 MPa or greater, and strength may be higher than this during mass production in some cases.

Further, Patent Document 2 discloses a method for manufacturing an electric resistance welded steel pipe having improved strength by rolling a steel slab having a carbon content of 0.05 to 0.12 wt % followed by winding at a temperature of 300° C. or less to form a homogeneous bainite structure.

However, the invention of Patent Document 2 has problems in that it may be difficult to control a low winding temperature and sheet shape may not be uniform because the hot rolled steel sheet should be wound at a temperature of 300° C. or less.

### RELATED ART

### Patent Document

(Patent Document 1) Korean Patent Laid-Open Publication No. 2013-0046920

(Patent Document 2) Korean Patent Laid-Open Publication No. 2013-0048796

### SUMMARY

An aspect of the present invention is directed to a method for manufacturing a hot rolled steel sheet and steel pipe for oil country tubular goods (OCTG), which satisfy the strength requirement of API standard 5CT P110, that is, a yield strength of 758 to 965 MPa and a tensile strength of 862 MPa or greater, and also have excellent processability, without requiring a heat treatment after pipe making.

The present invention relates to a hot rolled steel sheet for oil country tubular goods (OCTG) comprising C: 0.08 to 0.18 wt %, Si: 0.10 to 0.50 wt %, Mn: 1.2 to 2.0 wt %, P: 0.020 wt % or less, S: 0.003 wt % or less, Nb: 0.04 to 0.1 wt %, Cr: 0.05 to 0.5 wt %, Ti: 0.01 to 0.05 wt %, B: 0.0005 to 0.003 wt %, Ca: 0.001 to 0.006 wt %, N: 0.008 wt % or less, a balance of Fe and inevitable impurities, satisfying Relational Expression 1.

16≦30[C]+5[Mn]+5[Si]+6[Cr]+600[B]<17.5 [Relational Expression 1]

Wherein, [C], [Mn], [Si], [Cr] and [B] refer to wt % of each ingredient.

Another embodiment of the present invention relates to a method for manufacturing a hot rolled steel sheet for oil country tubular goods (OCTG), which comprises: heating a steel slab, satisfying the above alloy composition to a temperature within a range of 1100° C. to 1300° C.; subjecting the heated steel slab to rough rolling at a temperature of 900° C. to 1100° C.; subjecting the rough rolled slab to finish rolling to form a steel sheet; cooling the finish rolled steel sheet to a temperature of 400° C. to 520° C.; and winding the cooled steel sheet at a temperature within a range of 400° C. to 520° C.

In addition, the means for solving the problem does not list all features of the present invention. Further features, advantages and effects of the present invention will become apparent from the following description of exemplary embodiments.

### DETAILED DESCRIPTION

Hereinafter, embodiments of the present inventive concept will be described as follows with reference to the attached drawings.

The present inventive concept may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the present inventive concept. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present inventive concept will be described with reference to schematic views illustrating embodiments of the present inventive concept. In the drawings, for example, due to manufacturing techniques and/or tolerances, modifications of the shape shown may be estimated. Thus, embodiments of the present inventive concept should not be construed as being limited to the particular shapes of regions shown herein, for example, to include a change in shape results in manufacturing. The following embodiments may also be constituted by one or a combination thereof.

The contents of the present inventive concept described below may have a variety of configurations and propose only a required configuration herein, but are not limited thereto.

Exemplary embodiments of the present invention will be described below in detail with reference to the accompanying drawings. Wherever possible, the same reference numerals will be used to refer to the same elements throughout the specification, and duplicated descriptions thereof will be omitted. It will be understood that although the terms “first”, “second”, etc. are used herein to describe various elements, these elements should not be limited by these terms. These terms are only used to distinguish one element from another element.

The present inventors completed the present invention after finding that a hot rolled steel sheet and steel pipe for oil country tubular goods (OCTG), satisfying strength required to API standard 5CT P110, that is, a yield strength of 758 to 965 MPa and a tensile strength of 862 MPa or greater, and also has excellent processability, can be manufactured without requiring a heat treatment after pipe making by properly controlling the alloy composition and the manufacturing method.

Hereinafter, the hot rolled steel sheet for an oil well pipe according to an aspect of the present invention will be described in detail.

The hot rolled steel sheet for an oil well pipe according to an aspect of the present invention comprises C: 0.08 to 0.18 wt %, Si: 0.10 to 0.50 wt %, Mn: 1.2 to 2.0 wt %, P: 0.020 wt % or less, S: 0.003 wt % or less, Nb: 0.04 to 0.1 wt %, Cr: 0.05 to 0.5 wt %, Ti: 0.01 to 0.05 wt %, B: 0.0005 to 0.003 wt %, Ca: 0.001 to 0.006 wt %, N: 0.008 wt % or less, a balance of Fe and inevitable impurities, and satisfies Relational Expression 1.

16≦30[C]+5[Mn]+5[Si]+6[Cr]+600[B]<17.5 [Relational Expression 1]

Wherein, [C], [Mn], [Si], [Cr] and [B] refer to wt % of each ingredient.

First of all, the alloy composition of the hot rolled steel sheet for an oil well pipe according to an aspect of the present invention will be described in detail.

C: 0.08 to 0.18 wt %

C is an element increasing hardenability of the steel material. However, if a content of C is less than 0.08 wt %, hardenability may be insufficient, whereby the strength aimed in the present invention cannot be secured, but if the content is greater than 0.18 wt %, CEQ may be increased, thereby weldability may be deteriorated. Thus, the C content may preferably be 0.08 to 0.18 wt %.

Si: 0.10 to 0.50 wt %

Si is an element increasing C activity in a ferrite phase, accelerating ferrite stability, and increasing strength through high-temperature strengthening. Further, when conducting electric resistance welding, Si forms an oxide such as Mn₂SiO₄ having a low melting point, thereby allowing the oxide to be easily released. If the Si content is lower than 0.10 wt %, there may be a cost problem in the steelmaking process, and if the content is greater than 0.50 wt %, the amount of SiO₂ (an oxide having a higher melting point than Mn₂SiO₄) formed may be increased, whereby toughness of an welding part may be reduced when conducting electric resistance welding. Thus, the Si content may preferably be 0.10 to 0.50 wt %.

Mn: 1.2 to 2.0 wt %

Mn is an element effective in solid solution strengthening of the steel. A content thereof should be 1.2 wt % or greater to obtain a hardenability increase effect and to secure the strength aimed for in the present invention. However, a content thereof greater than 2.0 wt % is not preferable because a segregation part is largely developed in the mid-thickness region when casting the steel slab in the steelmaking process and weldability of the final product is degraded.

P: 0.02 wt % or less

P is an impurity deteriorating toughness. Thus, a lower content thereof is preferable. But the upper limit is limited to 0.02 wt % or less in consideration of cost in the steel manufacturing step.

S: 0.003 wt % or less

S is an element easily able to form coarse inclusions, causing reductions in toughness or the development of cracks. Thus, it is preferable for a content thereof to be as low as possible. However, the upper limit is limited to 0.003 wt % or less in consideration of the cost in the steel manufacturing step. More preferably, it is preferable for a content thereof to be in an amount of 0.002 wt % or less.

Nb: 0.04 to 0.1 wt %

Nb is an element affecting the strength of steel by forming precipitates. Thus, improved strength may be provided to steel by precipitating carbonitride from the steel, or by solid solution strengthening in Fe. In particular, the Nb-based precipitates are dissolved when reheating the steel slab and then minutely precipitated during hot rolling, thereby effectively increasing strength of the steel. However, in the case that the Nb content is lower than 0.04 wt %, fine precipitates may not be formed enough. Thus, the strength aimed for in the present invention cannot be secured. On the other hand, if the Nb content is higher than 0.1 wt %, continuous casting properties, rolling properties and strechability may be reduced due to excess precipitation. Thus, it is preferable to add Nb in an amount of 0.04 to 0.1 wt %.

Cr: 0.05 to 0.5 wt %

Cr is an element improving hardenability. If the Cr content is lower than 0.05 wt %, a hardenability improvement effect through the addition thereof may be insufficient, and if a content of Cr is greater than 0.5 wt %, toughness may be rapidly reduced. Thus, it is preferable to add Cr in an amount of 0.05 to 0.5 wt %.

Ti: 0.01 to 0.05 wt %

Ti reacts with N to form TiN. Thus, Ti plays a role in enhancing strength during slab reheating and by inhibiting growth of austenite grains in a HAZ (Heat affected zone) part. Further, solid solution state B contributing to hardenability improvement is ensured by removing solid solution state N and inhibiting BN formation at the same time through TiN formation. For this purpose, Ti should be contained in an amount of 3.4N or more. Thus, it is preferable to add Ti in an amount of 0.01 wt % or more. However, if Ti is added excessively, toughness may be reduced by coarse TiN and the like. Thus, the upper limit is limited to 0.05 wt % in the present invention.

B: 0.0005 to 0.003 wt %

B is an element, segregated at austenite grains, thereby stabilizing the austenite by lowering grain boundary energy, and delaying ferrite nucleation at grain boundaries, thereby improving hardenability of the steel. If the B content is lower than 0.0005 wt %, a hardenability improving effect may be insufficient, and if B is added in an amount greater than 0.003 wt %, boron oxide may be easily formed, thereby rapidly increasing brittleness of the steel. Thus, it is preferable to add B in an amount of 0.0005 to 0.003 wt %.

Ca: 0.001 to 0.006 wt %

Ca is an element added to control morphology of sulfide. If a content thereof is greater than 0.006%, a CaS cluster may be generated due to Ca being excessively added against the S content during steelmaking, but if Ca is less than 0.001%, MnS is generated, whereby Ca may cause a reduction in toughness. Thus, the Ca content may preferably be 0.001 to 0.006 wt %.

N: 0.008% or less

N is an inevitable impurity, and N fixes Ti and the like as a nitride in the steel. If a content of N is greater than 0.008%, the addition amounts of Ti and the like are inevitably increased. Thus, it is preferable to limit the N content to 0.008% or less.

The remainder of the present invention is Fe. However, unintentional impurities may be inevitably incorporated from raw materials or the surrounding environment in a general manufacturing process. Thus, the inclusion of such impurities cannot be ruled out. Because these impurities will be apparent to those skilled in the general manufacturing process, descriptions thereof will not be specifically provided in the present disclosure.

Further, preferably, the hot rolled steel sheet for oil country tubular goods (OCTG) according to the present invention satisfies the above alloy composition and Relational Expression 1 at the same time.

16≦30[C]+5[Mn]+5[Si]+6[Cr]+600[B]<17.5 [Relational Expression 1]

Wherein, [C], [Mn], [Si], [Cr] and [B] refer to wt % of each ingredient.

All of C, Mn, Si, Cr and B are elements contributing to strength. If the value of the Relational Expression 1 is less than 16, strength may be insufficient under the same operation conditions, and if the relational expression is greater than 17.5, processing may be difficult because strength may be exceeded or distributed at the upper limit.

At this time, according to another aspect of the present invention, the present invention may further comprise at least one selected from Cu: 0.5 wt % or less (excluding 0 wt %), Ni: 0.5 wt % or less (excluding 0 wt %), V: 0.5% or less (excluding 0 wt %), and Mo: 0.5% or less (excluding 0 wt %).

Cu: 0.5 wt % or less (excluding 0 wt %)

Cu is an element which plays a role in increasing strength of a matrix structure due to having a solid solution strengthening effect, and improving strength of the steel sheet by precipitation in high temperature environments. Further, Cu plays a role in improving corrosion resistance. In order to obtain effects of improving strength and corrosion resistance, Cu should be added in an enough amount. However, if Cu is added in an amount greater than 0.5%, the steel sheet may be cracked during rolling. Thus, a content of Cu is limited.

Ni: 0.5 wt % or less (excluding 0 wt %)

Ni is a high-temperature strengthening element increasing strength of the steel sheet without much reducing low temperature impact toughness. Ni has an effect of reducing cracks in the surface of a steel slab containing Cu. In order to obtain the effect, Ni should be added in an enough amount, but if Ni is added in an amount of greater than 0.5%, the cost of materials is too greatly increased, compared to the effect obtained by the addition thereof. Thus, a content thereof is limited.

V: 0.5% or less (excluding 0 wt %)

V plays a role in increasing strength of the steel sheet by a precipitation hardening effect. In order to obtain the effect, V should be added in an enough amount, but if V is added in an amount of greater than 0.5%, the manufacturing cost of materials may be increased, and toughness may be rapidly reduced. Thus, a content thereof is limited.

Mo: 0.5% or less (excluding 0 wt %)

Mo is effective in securing strength of materials and toughness at the same time by increasing hardenability. In order to obtain these effects, Mo should be added in an enough amount, but if Mo is added in an amount of greater than 0.5%, the manufacturing cost of materials is too greatly increased, compared to the effect obtained by the addition thereof. Thus, a content thereof is limited.

It is possible to manufacture a steel pipe for oil country tubular goods (OCTG) having a yield strength of 758 to 965 MPa and a tensile strength of 862 MPa by subjecting the hot rolled steel sheet, satisfying the alloy composition as described above, to pipe making, followed by subjecting the piper formed thereof to electric resistance welding.

Hereinafter, a method for manufacturing a hot rolled steel sheet for oil country tubular goods (OCTG) as another aspect of the present invention will be described in detail.

As another aspect of the present invention, the method for manufacturing a hot rolled steel sheet for oil country tubular goods (OCTG) comprises: heating the steel slab satisfying the alloy composition mentioned above to a temperature within a range of 1100° C. to 1300° C.; subjecting the heated steel slab to rough rolling at a temperature of 900° C. to 1100° C.; subjecting the rough rolled slab to finish rolling to form a steel sheet; cooling the finish rolled steel sheet to a temperature of 400° C. to 520° C.; and winding the quenched steel sheet at a temperature within a range of 400° C. to 520° C.

Heating Step

Preferably, the steel slab reheating is conducted at a temperature within a range of 1100° C. to 1300° C. The steel slab reheating process is a process of heating the steel to smoothly conduct the follow-up rolling process and to obtain the aimed at physical properties of the steel sheet. Thus, the heating process should be conducted within a proper temperature range to serve the purpose. When heating the steel slab, if the heating temperature is lower than 1100° C., it may be difficult to completely dissolve Nb, but if it the heating temperature is greater than 1300° C., refining of particle-size distribution may be difficult because initial grains may be excessively large.

Rough rolling Step and Finish Rolling Step

Preferably, rough rolling may be conducted at a temperature of 900° C. to 1100° C. When rough rolling is completed at a temperature of 900° C. or less, there may be a risk of generating an equipment load problem of a roller. Then, finish rolling may be conducted in a non-recrystallization temperature region of 750 to 900° C. If the temperature is greater than 900° C., the desired strength cannot be obtained because the final structure may be coarse, and if the temperature is lower than 750° C., there may be a risk of generating a abnormal grain structure.

Cooling Step

The cooling is a factor for improving toughness and strength of the steel sheet. As the cooling rate is increased, grains in an internal structure of the steel sheet are refined, thereby improving toughness, and a relatively hard structure is developed in the steel sheet, thereby improving strength. For this, when cooling, the cooling rate may preferably be 10° C./s or greater. If the cooling rate is lower than 10° C./s, the desired strength cannot be obtained due to insufficient hard phase formation.

Preferably, the cooling may be conducted at a temperature of 400° C. to 520° C. If the cooling stop temperature is greater than 520° C., strength may be insufficient due to insufficient hard phase formation, and if the cooling stop temperature is controlled to be less than 400° C., yield strength may be exceeded due to martensite formation.

Winding Step

After cooling, winding may preferably be conducted at a temperature of 400° C. to 520° C. If the temperature is greater than 520° C., yield strength may be insufficient due to insufficient hard phase formation, and if the winding is conducted at a temperature less than 400° C., yield strength may be exceeded due to martensite formation.

On the other hand, a steel pipe is manufactured by using the hot rolled steel sheet manufactured as described above. The method for manufacturing the steel pipe is not particularly limited, but it is preferable to make a pipe using electric resistance welding which is the most economic method. Instead of electric resistance welding, any welding method can be used, and therefore, the welding method is not particularly limited.

### MODE FOR INVENTION

Hereinafter, the present disclosure will be described in greater detail with reference to examples. However, the following examples are for illustrative purposes only, and should not be seen as limiting the scope of the present disclosure. The scope of the present disclosure should be determined by the claims and information reasonably inferable therefrom.

A steel slab satisfying the composition of the following Table 1 (wt %, with a remainder of Fe and inevitable impurities) was reheated (SRT), rough rolled, hot finish rolled (FDT), cooled and then wound (CT) under the conditions of Table 2 to manufacture a hot rolled steel sheet.

Further, in order to determine whether each Example and Comparative Example satisfy Relational Expression 1 (16≦30[C]+5[Mn]+5[Si]+6[Cr]+600[B]<17.5) of the present invention or not, values of the expression are listed in Table 1.

Yield strength and tensile strength of the hot rolled steel sheets manufactured as described above were measured using a tensile tester according to ASTM A370 standard. The results are shown in Table 2.

TABLE 1

| | | | | | | | | | | | | | Relational |
|---|---|---|---|---|---|---|---|---|---|---|---|---|---|
| Section | C | Si | Mn | P | S | Ca | N | Nb | Cr | Ti | V | B | Expression 1 |
| Example 1 | 0.12 | 0.35 | 1.8 | 0.01 | 0.002 | 0.003 | 0.005 | 0.06 | 0.4 | 0.037 | 0 | 0.001 | 17.35 |
| Example 2 | 0.12 | 0.34 | 1.8 | 0.01 | 0.002 | 0.002 | 0.004 | 0.06 | 0.4 | 0.037 | 0 | 0.001 | 17.30 |
| Example 3 | 0.12 | 0.34 | 1.8 | 0.01 | 0.002 | 0.003 | 0.004 | 0.06 | 0.4 | 0.037 | 0 | 0.001 | 17.30 |
| Example 4 | 0.12 | 0.34 | 1.8 | 0.01 | 0.002 | 0.003 | 0.005 | 0.06 | 0.4 | 0.037 | 0 | 0.001 | 17.30 |
| Example 5 | 0.11 | 0.34 | 1.8 | 0.01 | 0.002 | 0.002 | 0.003 | 0.07 | 0.4 | 0.014 | 0 | 0.001 | 17.00 |
| Example 6 | 0.11 | 0.35 | 1.7 | 0.01 | 0.002 | 0.002 | 0.003 | 0.05 | 0.35 | 0.014 | 0 | 0.001 | 16.25 |
| Comparative | 0.11 | 0.35 | 1.7 | 0.01 | 0.002 | 0.002 | 0.003 | 0.05 | 0.35 | 0.014 | 0 | 0.001 | 16.25 |
| Example 1 | | | | | | | | | | | | | |
| Comparative | 0.11 | 0.34 | 1.8 | 0.01 | 0.002 | 0.002 | 0.003 | 0.07 | 0.4 | 0.014 | 0 | 0.001 | 17.00 |
| Example 2 | | | | | | | | | | | | | |
| Comparative | 0.07 | 0.34 | 1.7 | 0.01 | 0.002 | 0.002 | 0.004 | 0.07 | 0.35 | 0.013 | 0 | 0.001 | 15.00 |
| Example 3 | | | | | | | | | | | | | |
| Comparative | 0.11 | 0.35 | 1.7 | 0.01 | 0.002 | 0.002 | 0.004 | 0.09 | 0.35 | 0.013 | 0 | 0 | 15.65 |
| Example 4 | | | | | | | | | | | | | |
| Comparative | 0.04 | 0.34 | 1.8 | 0.01 | 0.002 | 0.002 | 0.004 | 0.1 | 0.4 | 0.013 | 0 | 0.001 | 14.90 |
| Example 5 | | | | | | | | | | | | | |
| Comparative | 0.07 | 0.34 | 1.7 | 0.01 | 0.002 | 0.003 | 0.004 | 0.07 | 0.35 | 0.014 | 0 | 0.001 | 15.00 |
| Example 6 | | | | | | | | | | | | | |

In the above Table 1, each content ingredient is represented as wt %.

TABLE 2

| | | | | yield | tensile |
|---|---|---|---|---|---|
| | | | | strength | strength |
| Section | SRT (° C.) | FDT (° C.) | CT (° C.) | (MPa) | (MPa) |
| Example 1 | 1293 | 828 | 414 | 858 | 961 |
| Example 2 | 1290 | 835 | 505 | 853 | 928 |
| Example 3 | 1292 | 832 | 480 | 845 | 952 |
| Example 4 | 1295 | 831 | 466 | 838 | 914 |
| Example 5 | 1261 | 809 | 467 | 836 | 897 |
| Example 6 | 1293 | 831 | 508 | 827 | 883 |
| Comparative | 1292 | 841 | 526 | 786 | 846 |
| Example 1 | | | | | |
| Comparative | 1262 | 912 | 555 | 712 | 840 |
| Example 2 | | | | | |
| Comparative | 1288 | 808 | 491 | 704 | 771 |
| Example 3 | | | | | |
| Comparative | 1292 | 808 | 445 | 685 | 765 |
| Example 4 | | | | | |
| Comparative | 1269 | 810 | 489 | 675 | 760 |
| Example 5 | | | | | |
| Comparative | 1289 | 809 | 450 | 661 | 779 |
| Example 6 | | | | | |

As can be seen from the above Tables 1 and 2, Examples 1 to 6 satisfying the ingredient range of the present invention and the Relational Expression 1 satisfy API standard (yield strength of 758 to 965 MPa, tensile strength of 862 MPa or greater) aimed in the present invention.

However, it can be seen that Comparative Examples 3 to 6 do not satisfy the ingredient range of the present invention or Relational Expression 1, thereby they do not satisfy the above conditions of yield strength and tensile strength.

Further, it can be seen that Comparative Examples 1 and 2 satisfy the ingredient range of the present invention and Relational Expression 1, but they do not satisfy the above conditions of yield strength and tensile strength because the winding temperature is greater than 520° C.

The present invention has an effect of providing a method for manufacturing a hot rolled steel sheet and steel pipe for oil country tubular goods (OCTG), which can satisfy strength required under API standard 5CT P110, that is, a yield strength of 758 to 965 MPa and a tensile strength of 862 MPa or greater, and also has excellent processability, without a heat treatment after pipe making.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A hot rolled steel sheet for oil country tubular goods (OCTG) comprises C: 0.08 to 0.18 wt %, Si: 0.10 to 0.50 wt %, Mn: 1.2 to 2.0 wt %, P: 0.020 wt % or less, S: 0.003 wt % or less, Nb: 0.04 to 0.1 wt %, Cr: 0.05 to 0.5 wt %, Ti: 0.01 to 0.05 wt %, B: 0.0005 to 0.003 wt %, Ca: 0.001 to 0.006 wt %, N: 0.008 wt % or less, a balance of Fe and inevitable impurities, and
satisfies Relational Expression 1,
16≦30[C]+5[Mn]+5[Si]+6[Cr]+600[B]<17.5 [Relational Expression 1]
wherein, [C], [Mn], [Si], [Cr] and [B] refer to wt % of each ingredient.

2. The hot rolled steel sheet for oil country tubular goods (OCTG) of claim 1, wherein the hot rolled steel sheet further comprises at least one selected from Cu: 0.5 wt % or less (excluding 0 wt %), Ni: 0.5 wt % or less (excluding 0 wt %), V: 0.5% or less (excluding 0 wt %), and Mo: 0.5% or less (excluding 0 wt %).

3. A steel pipe for oil country tubular goods (OCTG), which is manufactured by forming a pipe from the hot rolled steel sheet of claim 1, followed by subjecting the pipe to electric resistance welding, and has yield strength of 758 to 965 MPa and tensile strength of 862 MPa or greater.

4. The steel pipe for oil country tubular goods (OCTG) of claim 3, wherein the hot rolled steel sheet further comprises at least one selected from Cu: 0.5 wt % or less (excluding 0 wt %), Ni: 0.5 wt % or less (excluding 0 wt %), V: 0.5% or less (excluding 0 wt %), and Mo: 0.5% or less (excluding 0 wt %).

5. A method for manufacturing a hot rolled steel sheet for oil country tubular goods (OCTG), which comprises:
heating a steel slab, which comprises C: 0.08 to 0.18 wt %, Si: 0.10 to 0.50 wt %, Mn: 1.2 to 2.0 wt %, P: 0.020 wt % or less, S: 0.003 wt % or less, Nb: 0.04 to 0.1 wt %, Cr: 0.05 to 0.5 wt %, Ti: 0.01 to 0.05 wt %, B: 0.0005 to 0.003 wt %, Ca: 0.001 to 0.006 wt %, N: 0.008 wt % or less, a balance of Fe and inevitable impurities, and satisfies Relational Expression 1, at a temperature within a range of 1100° C. to 1300° C.;
subjecting the heated steel slab to rough rolling at a temperature of 900° C. to 1100° C.;
subjecting the rough rolled slab to finish rolling to form a steel sheet;
cooling the finish rolled steel sheet to a temperature of 400° C. to 520° C.; and
winding the cooled steel sheet at a temperature within a range of 400° C. to 520° C.,
16≦30[C]+5[Mn]+5[Si]+6[Cr]+600[B]<17.5 [Relational Expression 1]
wherein, [C], [Mn], [Si], [Cr] and [B] refer to wt % of each ingredient.

6. The method for manufacturing a hot rolled steel sheet for oil country tubular goods (OCTG) of claim 5, wherein the steel slab further comprises at least one selected from Cu: 0.5 wt % or less (excluding 0 wt %), Ni: 0.5 wt % or less (excluding 0 wt %), V: 0.5% or less (excluding 0 wt %), and Mo: 0.5% or less (excluding 0 wt %).

7. The method for manufacturing a hot rolled steel sheet for oil country tubular goods (OCTG) of claim 5, wherein the cooling is conducted at a cooling rate of 10° C./s or greater.

8. The method for manufacturing a hot rolled steel sheet for oil country tubular goods (OCTG) of claim 5, wherein the finish rolling is conducted at non-recrystallization temperature region of 750 to 900° C.
